(19) United States
(12) Patent Application Publication
(10) Pub. No.: US 2020/0175525 A1
(43) Pub. Date: Jun. 4, 2020

(54) INFORMATION PROVIDING DEVICE, VEHICLE CONTROL SYSTEM, INFORMATION PROVIDING METHOD, AND STORAGE MEDIUM

(71) Applicant: HONDA MOTOR CO., LTD., Tokyo (JP)

(72) Inventors: Naoko Imai, Wako-shi (JP); Yasushi Ikeuchi, Wako-shi (JP); Takeyuki Suzuki, Wako-shi (JP)

(21) Appl. No.: 16/693,446

(22) Filed: Nov. 25, 2019

(30) Foreign Application Priority Data
Nov. 29, 2018 (JP) 2018-223502

(51) Int. Cl. G06Q 30/00; G06Q 30/06; G06Q 50/12

(52) U.S. Cl. CPC G06Q 30/0185; G06Q 50/12; G06Q 30/0643

(57) ABSTRACT

An information providing device includes an image acquirer that acquires a cooking image obtained by capturing an image of a process of cooking food ordered by a customer outside a store using an imaging device and a provider that provides the cooking image acquired by the image acquirer to a terminal device which is used by the customer.

### CROSS-REFERENCE TO RELATED APPLICATION

Priority is claimed on Japanese Patent Application No. 2018-223502, file Nov. 29, 2018, the content of which is incorporated herein by reference.

### BACKGROUND

### Field of the Invention

The present invention relates to an information providing device, a vehicle control system, an information providing method, and a storage medium.

### Description of Related Art

Since the past, a technique in which a process related to an order is executed in a customer's terminal device so that the customer who is on board a vehicle can simplify an order at a drive-through has been known (for example, Japanese Unexamined Patent Application, First Publication No. 2012-027731).

### SUMMARY

However, in the technique of the related art, it was impossible for a user to confirm that an ordered commercial product was being appropriately cooked.

An aspect of the present invention was contrived in view of such circumstances, and one object thereof is to provide an information providing device, a vehicle control system, an information providing method, and a storage medium that makes it possible for a user to confirm that an ordered commercial product is appropriately cooked.

An information providing device, a vehicle control system, an information providing method, and a storage medium according to this invention have the following configurations adopted therein.

(1) According to an aspect of this invention, there is provided an information providing device including: an image acquirer that acquires a cooking image obtained by capturing an image of a process of cooking food ordered by a customer outside a store using an imaging device; and a provider that provides the cooking image acquired by the image acquire to a terminal device which is used by the customer.

(2) In the aspect of the above (1), the provider provides information relating to foodstuffs of the ordered food to the terminal device.

(3) In the aspect of the above (1), the image acquire further acquires an order process image obtained by capturing an image of a process until cooking is started after the food is ordered using an imaging device, and the provider further provides the order process image to the terminal device.

(4) In the aspect of the above (1), the cooking image includes an image representing identification information for identifying the customer who has ordered the food.

(5) In the aspect of the above (1), the information providing device further includes an acceptor that accepts a request for start of a dialogue with a cook of the food or a producer of foodstuffs used in the food from the customer who has ordered the food, and the provider starts a dialogue through the terminal device in a case where the cook or the producer responding to the request for start of a dialogue accepted by the acceptor is able to respond thereto.

(6) In the aspect of the above (5), the dialogue includes an inquiry from the customer for a cook of the food or the producer of foodstuffs used in the food, and the cooking image includes an image representing a reply of the cook or the producer to the inquiry.

(7) In the aspect of the above (1), the information providing device further includes: an order deriver that derives a cooking order on the basis of order information in which the food and identification information for identifying the customer who has ordered the food are associated with each other and information indicating a time of arrival of the customer at the store; and a presentator that presents the cooking order derived by the order deriver to a cook.

(8) In the aspect of the above (1), the information providing device further includes a time deriver that derives a recommended time of arrival at the store for each customer on the basis of order information in which the food and identification information for identifying the customer who has ordered the food are associated with each other and information indicating a cooking time of the food, and the provider provides the recommended arrival time derived by the time deriver to the terminal device or a vehicle control device of the corresponding customer.

(9) According to an aspect of this invention, there is provided a vehicle control system including: the information providing device according to the aspect of the above (8); and a vehicle control device including a recognizer that recognizes an object including another vehicle which is present in the vicinity of a host vehicle and a driving controller that generates a target trajectory of the host vehicle on the basis of a state of the object recognized by the recognizer and controls one or both of speed and steering of the host vehicle on the basis of the generated target trajectory, wherein the vehicle control device controls the host vehicle so as to arrive at the store at the recommended arrival time provided from the information providing device or through the terminal device.

(10) According to an aspect of this invention, there is provided an information providing method including causing a computer to: acquire a cooking image obtained by capturing an image of a process of cooking food ordered by a customer outside a store using an imaging device; and provide the acquired cooking image to a terminal device which is used by the customer.

(11) According to an aspect of this invention, there is provided a storage medium having a program stored therein, the program causing a computer to: acquire a cooking image obtained by capturing an image of a process of cooking food ordered by a customer outside a store using an imaging device; and provide the acquired cooking image to a terminal device which is used by the customer.

According to (1) to (14), it is possible for a user to confirm that an ordered commercial product is being appropriately cooked.

According to (2), it is possible for a user to confirm that an ordered commercial product is being cooked using appropriate foodstuffs. As a result, it is possible to enhance a user's sense of security with respect to a commercial product.

According to (3), it is possible for a user to confirm that an ordered commercial product is being cooked in an appropriate order. As a result, it is possible for a user to confirm that the user's order is not neglected or unduly postponed.

According to (6), it is possible to realize a dialogue with a cook and a user, and to eliminate a user's doubt about a commercial product.

According to (8), it is possible to provide a user with a commercial product at an appropriate time.

### BRIEF DESCRIPTION OF THE DRAWINGS

FIG. 1 is a diagram illustrating an example of a configuration of an information providing device 10 according to an embodiment.

FIG. 2 is a diagram illustrating an example of content of order information 121.

FIG. 3 is a diagram illustrating an example of a sketch drawing of a store SF.

FIG. 4 is a diagram illustrating an example of an image which is displayed by a terminal device 20.

FIG. 5 is a diagram illustrating an example of content of ingredient information 122.

FIG. 6 is a diagram illustrating an example of a first image IM1 which is displayed by the terminal device 20.

FIG. 7 is a diagram illustrating an example of an execution screen of an inquiry application which is executed in the terminal device 20.

FIG. 8 is a diagram illustrating an example of content of inquiry information IQ.

FIG. 9 is a diagram illustrating an example of a second image IM2 which is displayed by the terminal device 20.

FIG. 10 is a diagram illustrating an example of content of cooking time information 123.

FIG. 11 is a diagram illustrating an example of a third image IM3 which is displayed by the terminal device 20.

FIG. 12 is a diagram illustrating an example of a recommended route redetermined by an MPU.

FIG. 13 is a diagram illustrating an example of content of arrival time information 124.

FIG. 14 is a diagram illustrating an example of content of cooking order information OF.

FIG. 15 is a diagram illustrating an example of a customer image which is displayed by a display device 50.

FIG. 16 is a flow chart illustrating an example of a flow of operations in a process of providing a process image to the terminal device 20.

FIG. 17 is a flow chart illustrating an example of a flow of operations in a process of providing a reply to an inquiry to the terminal device 20.

FIG. 18 is a flow chart illustrating an example of a flow of operations in a process of presenting a recommended arrival time to the terminal device 20.

FIG. 19 is a flow chart illustrating an example of a flow of operations in a process of presenting a cooking order to a cook.

### DESCRIPTION OF EMBODIMENTS

Hereinafter, an embodiment of an information providing device, a vehicle control system, an information providing method, and a storage medium of the present invention will be described with reference to the accompanying drawings.

### EMBODIMENT

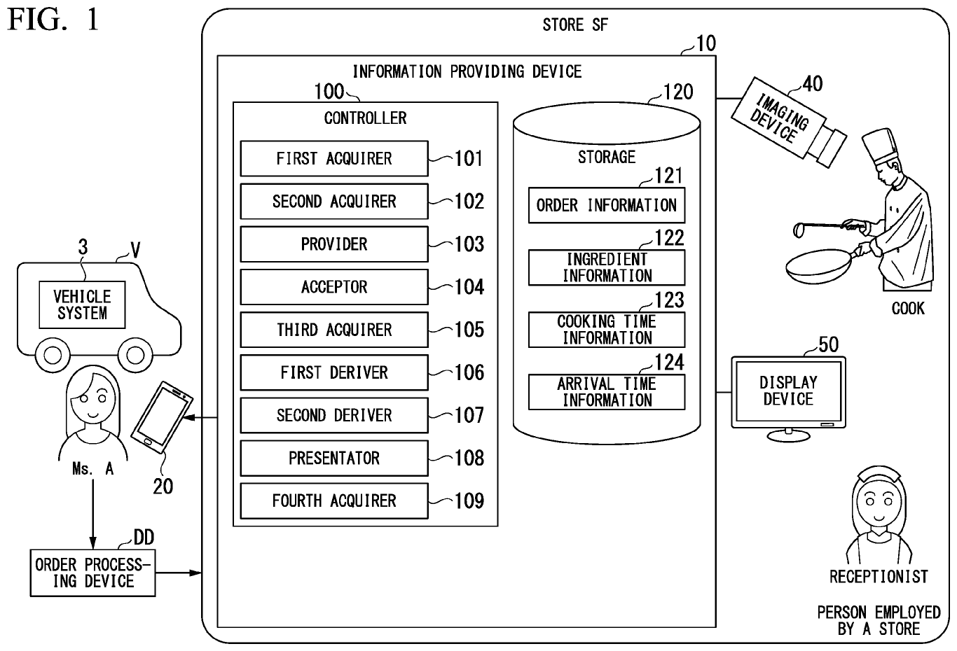

FIG. 1 is a diagram illustrating an example of a configuration of an information providing device 10 according to the present embodiment. The information providing device 10 is a device that provides a user outside a store for providing food (hereinafter referred to as a store SF) with information relating to cooking of food ordered by the user. The information providing device 10 communicates with a terminal device 20 or a vehicle system 3 using a cellular network, a Wi-Fi network, Bluetooth (registered trademark), a wide area network (WAN), a local area network (LAN), or the like, and transmits and receives various types of data.

### Terminal Device 20

The terminal device 20 is, for example, a terminal device which is used by a user, and is realized by a portable communication terminal device such as a smartphone, a portable personal computer such as a tablet-type computer (tablet PC), or the like. Hereinafter, the terminal device 20 is assumed to include a touch panel capable of both data input and data display. In the present embodiment, a user moves to the store SF while on board a vehicle V, and orders food before arriving at the store SF. A user orders food of the store SF from an order processing device DD through data communication using the terminal device 20. The order processing device DD is a device that accepts an order from a user and notifies a corresponding store SF of the accepted order. A user may order food through, for example, communication with a person employed by a store SF. A user is an example of a “customer of a store SF.”

### Vehicle System 3

Referring back to FIG. 1, the vehicle system 3 is a control device, provided in the vehicle V, which controls traveling of the vehicle V. Communication between the information providing device 10 and the vehicle system 3 may be performed using dedicated short range communication (DSRC).

The vehicle system 3 includes, for example, a camera, a radar device, a viewfinder, a human machine interface (HMI), a navigation device, a map positioning unit (MPU), a driving operator, an autonomous driving control device, a traveling drive force output device, a brake device, and a steering device. These devices or instruments are connected to each other through a multiplex communication line such as a controller area network (CAN) communication line, a serial communication line, a wireless communication network, or the like. The configuration of the vehicle system 3 is merely an example, and portions of the configuration may be omitted, or other configurations may be further added.

The camera is a digital camera using a solid-state imaging element such as, for example, a charge coupled device (CCD) or a complementary metal oxide semiconductor (CMOS). The camera, for example, repeatedly captures an image of the vicinity of the vehicle V periodically. The radar device radiates radio waves such as millimeter waves to the vicinity of the vehicle V, and detects radio waves (reflected waves) reflected from an object to detect at least the position (distance to and orientation of) of the object. The viewfinder is a light detection and ranging (LIDAR) viewfinder. The viewfinder irradiates the vicinity of the vehicle V with light, and measures scattered light. The viewfinder detects a distance to an object on the basis of a time from light emission to light reception.

The navigation device includes, for example, a global navigation satellite system (GNSS) receiver and a route determiner. The navigation device holds first map information in a storage device such as a hard disk drive (HDD) or a flash memory. The GNSS receiver specifies the position of the vehicle V on the basis of a signal received from a GNSS satellite. The route determiner refers to the first map information to determine, for example, a route (hereinafter referred to as a route on a map) from the position (or any input position) of the vehicle V specified by the GNSS receiver to a destination (the store SF in this example) input by an occupant using a navigation HMI. The route on a map is output to the MPU.

The MPU includes, for example, a recommended lane determiner, and the recommended lane determiner divides the route on a map provided from the navigation device into a plurality of blocks (for example, divides the route on a map every 100 [m] in the traveling direction of the vehicle V), and determines a recommended lane for each block with reference to second map information. The recommended lane determiner makes a determination on which lane from the left to travel along. The second map information is map information having higher accuracy than that of the first map information. The second map information includes, for example, information of the center of a lane, information of the boundary of a lane, or information of the type of lane, or the like.

The MPU may change a recommended lane on the basis of a recommended arrival time which is provided from the information providing device 10. The details of the recommended arrival time which is provided from the information providing device 10 will be described later.

The driving operator includes, for example, an accelerator pedal, a brake pedal, a shift lever, a steering wheel, a variant steering wheel, a joystick, and other operators. A sensor that detects the amount of operation or the presence or absence of operation is installed on the driving operator, and the detection results are output to the autonomous driving control device, or some or all of the traveling drive force output device, the brake device and the steering device.

The autonomous driving control device includes, for example, a first controller, a second controller, and a storage. The first controller and the second controller are each realized by a processor such as, for example, a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), and may be realized by software and hardware in cooperation. The program may be stored in the storage of the autonomous driving control device in advance, may be stored in a detachable storage medium such as a DVD or a CD-ROM, or may be installed in the storage by the storage medium being mounted in a drive device.

The first controller includes, for example, a recognizer and a behavior plan generator. The recognizer recognizes the surrounding situation of the vehicle V on the basis of information input from which is the camera, the radar device and the viewfinder.

The recognizer recognizes, for example, a lane in which the vehicle V is traveling (traveling lane). The behavior plan generator generates a target trajectory along which the vehicle V will travel in the future so that the vehicle travels in a recommended lane determined by the recommended lane determiner in principle and autonomous driving corresponding to the surrounding situation of the vehicle V is further executed. The target trajectory includes, for example, a speed element.

The second controller acquires, for example, information of the target trajectory generated by the behavior plan generator, and controls the traveling drive force output device or the brake device, and the steering device. The behavior plan generator and the second controller are an example of a “driving controller.”

The traveling drive force output device outputs a traveling drive force (torque) for the vehicle V to travel to a driving wheel. The traveling drive force output device controls an internal-combustion engine, an electric motor, a transmission, and the like in accordance with, for example, information which is input from the second controller or information which is input from the driving operator. The brake device, for example, causes a brake torque according to a braking operation to be output to each wheel.

The steering device drives the electric motor in accordance with the information which is input from the second controller or the information which is input from the driving operator, and changes the direction of a turning wheel.

### Information Providing Device 10

The information providing device 10 is included in, for example, a store SF. An imaging device 40 and a display device 50 are connected to the information providing device 10. The imaging device 40 is installed in various places in the store SF. Whenever an order is accepted, the imaging device newly captures an image of a process until cooking is started after food is ordered by a user or an image of a process of cooking ordered food, and supplies a generated image to the information providing device 10. In the following description, an image obtained by capturing a process until cooking is started after food is ordered is described as an “order process image,” an image obtained by capturing a process of cooking food is described as a “cooking image,” and in a case where the “order process image” and the “cooking image” need not be distinguished from each other, these images are described as a “process image.” Examples of cooking images to be captured preferably include a kitchen, a cook, foodstuffs, a seasoning, a cookware, food which is being cooked, and the like. The display device 50 displays various images on the basis of control of the information providing device 10, and presents various types of information to a cook or a person employed by a store such as a receptionist.

The information providing device 10 may be provided in places other than a store SF. In this case, the information providing device 10 mutually communicates with the imaging device 40 and the display device 50 through a WAN, a LAN, the Internet, or the like, and functions as a cloud server that transmits and receives various types of data.

The information providing device 10 includes a controller 100 and a storage 120. The controller 100 realizes each functional unit of a first acquirer 101, a second acquirer 102, a provider 103, an acceptor 104, a third acquirer 105, a first deriver 106, a second deriver 107, a presentator 108, and a fourth acquirer 109, for example, by a hardware processor such as a CPU executing a program (software) stored in the storage 120.

Some or all of these components may be realized by hardware (including a circuit unit) such as an LSI, an ASIC, an FPGA, or a GPU, or may be realized by software and hardware in cooperation.

The storage 120 may be realized by a storage device (a storage device including a non-transitory storage medium) such as, for example, an HDD or a flash memory, may be realized by a detachable storage medium such as a DVD or a CD-ROM (a non-transitory storage medium), or may be a storage medium which is mounted in a drive device. Some or all of the storage 120 may be accessible external devices of the information providing device 10 such as an NAS or an external storage server. The storage 120 stores, for example, order information 121, ingredient information 122, cooking time information 123, and arrival time information 124. The details of the various types of information will be described later.

The first acquirer 101 acquires the order information 121 indicating an order from a user. The second acquirer 102 acquires a process image from the imaging device 40. The provider 103 provides the process image acquired by the second acquirer 102 or various types of information to the terminal device 20. The second acquirer 102 is an example of an “image acquirer.”

The acceptor 104 accepts an inquiry about a cook or a store SF from a user. The third acquirer 105 acquires a reply to the inquiry accepted by the acceptor 104. The provider 103 provides the reply acquired by the third acquirer 105 to the terminal device 20.

The first deriver 106 derives a time when it is desirable for the user to arrive at the store SF (hereinafter referred as a recommended arrival time). The provider 103 provides the recommended arrival time derived by the first deriver 106 to the terminal device 20.

The second deriver 107 derives a cooking order for a cook to cook food ordered by a user on the basis of an arrival time when the user arrives at a store SF. The presentator 108 displays the cooking order derived by the second deriver 107 on the display device 50, and presents the displayed cooking order to the cook. The fourth acquirer 109 acquires an image captured by the user. The presentator 108 displays the image captured by the user which is acquired by the fourth acquirer 109 on the display device 50, and presents the displayed image to a person employed by a store. Hereinafter, the details of each functional unit will be described.

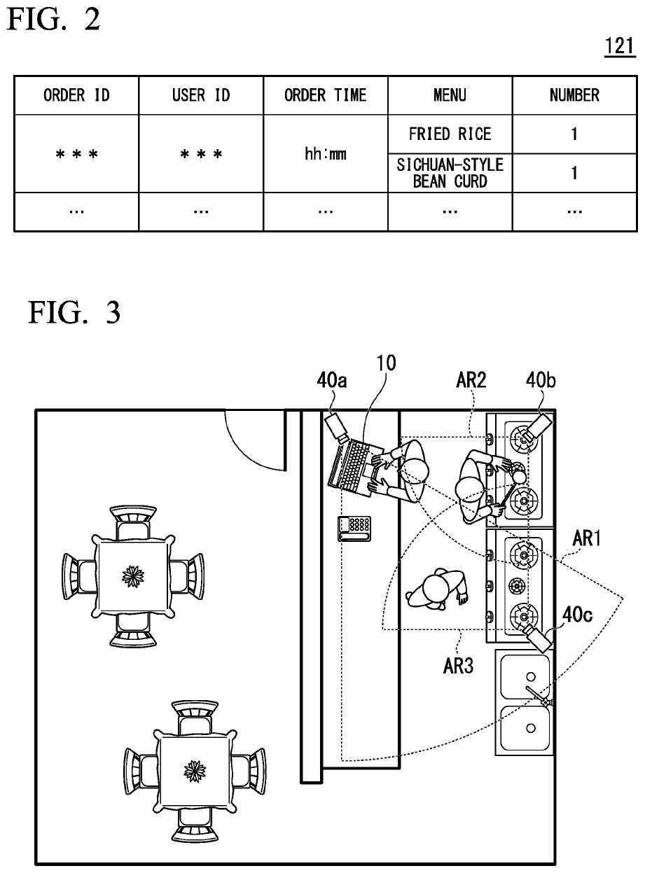

The first acquirer 101 acquires an order record indicating the user's order content, and stores the acquired order record as the order information 121 in the storage 120. FIG. 2 is a diagram illustrating an example of content of the order information 121. The order information 121 is, for example, information in which one or more order records including information capable of identifying an order (hereinafter referred to as an order ID), information capable of identifying a user who has performed an order (hereinafter referred to as a user ID), items of one or more ordered foods (hereinafter referred to as a menu item), and the number of foods are included. The order ID is, for example, a unique order number imparted for each order.

The user ID is, for example, a user's name or registration information registered when an order service using the order processing device DD is used. The first acquirer 101 acquires an order record from the order processing device DD using, for example, a cellular network, a Wi-Fi network, Bluetooth, a WAN, a LAN, the Internet, or the like, and stores the acquired order record inclusive of the order information 121 in the storage 120. The first acquirer 101 may acquire an order record by a person employed by a store who has accepted an order in a store SF directly inputting the order content to an input unit (not shown) which is connected to the information providing device 10, and store the acquired order record inclusive of the order information 121 in the storage 120.

The second acquirer 102 acquires a process image from the imaging device 40 in accordance with the first acquirer 101 acquiring an order record. FIG. 3 is a diagram illustrating an example of a sketch drawing of a store SF. In FIG. 3, three imaging devices 40 (imaging devices 40a to 40c shown in the drawing) are installed in the store SF. The imaging device 40a captures, for example, an image of a person employed by a store who confirms the order information 121, and generates an order process image. The imaging devices 40b and 40c capture an image of a kitchen, and generate a cooking image. Hereinafter, a case where the process image is a moving image with voice including a moving image and voice collected by a microphone (not shown) included in the imaging device 40 will be described. In a case where the imaging device 40 records video at all times, the second acquirer 102 extracts (trims) a process image generated after an order time indicated in the order information 121 in a generated image, and acquires the extracted image as a process image. In a case where the imaging device 40 records video or stops recording on the basis of control of the information providing device 10, the second acquirer 102 may acquire the generated process image by starting video recording of the imaging device 40 after a predetermined period of time (after, for example, several tens of seconds to several minutes) after the first acquirer 101 acquires the order record, or may acquire the process image by start video recording by a cook operating the imaging device 40 after the first acquirer 101 acquires the order record.

The second acquirer 102 causes the display device 50 to display a person employed by a store or an image representing an instruction for a cooking image during the acquisition of a process image for each user. For example, the second acquirer 102 causes the display device 50 installed at a position that can be visually recognized by a person employed by a store to display a message image of “Please transfer Ms. A's order to a cook,” and acquires an order process image captured by the imaging device 40a during display as an order process image of Ms. A. Similarly, the second acquirer 102 causes the display device 50 installed at a position that can be visually recognized by a cook to display a message image of “Please cook fried rice and Sichuan-style bean curd that Ms. A ordered,” and acquires cooking images captured by the imaging devices 40b and 40c during display as cooking images of Ms. A.

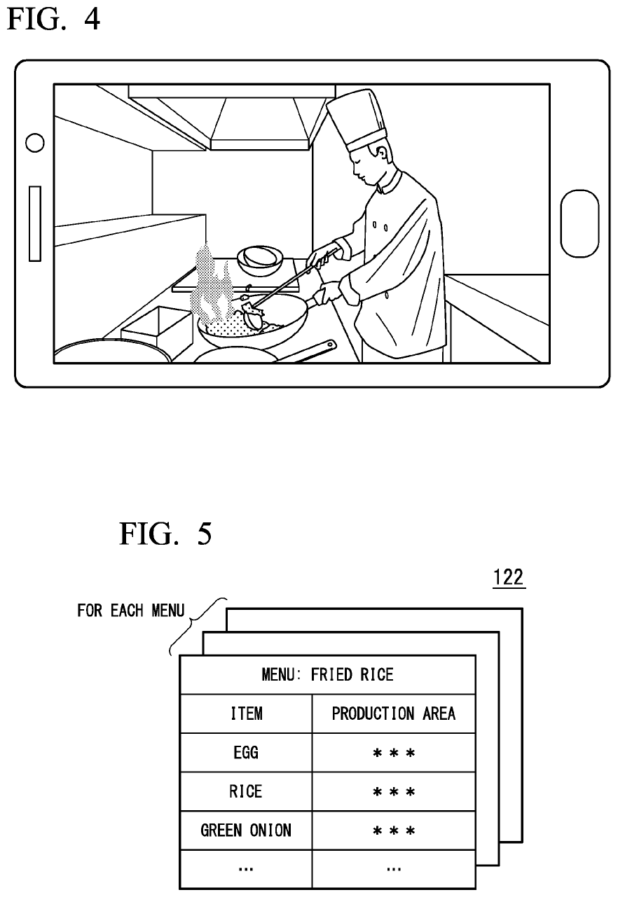

The provider 103 provides the terminal device 20 with a process image acquired by the second acquirer 102. The provider 103 provides the terminal device 20 immediately (for example, in real time) with, for example, an image acquired by the second acquirer 102. FIG. 4 is a diagram illustrating an example of an image which is displayed by the terminal device 20. The image shown in FIG. 4 is a cooking image. Instead, the provider 103 may provide the terminal device 20 with an order process image or may provide the terminal device 20 with an image including the order process image and the cooking image. By confirming the image which is displayed by the terminal device 20, a user can confirm that ordered food is being appropriately cooked. As a result, it is possible to enhance a user's sense of security with respect to a commercial product.

The provider 103 may provide the terminal device 20 with the process image acquired by the second acquirer 102 inclusive of an image representing various types of information. Hereinafter, in a case where the provider 103 provides the terminal device 20 with a process image inclusive of information relating to foodstuffs of food will be described. The provider 103 refers to the ingredient information 122 to specify foodstuffs used in cooking of a menu item included in an order record.

FIG. 5 is a diagram illustrating an example of content of the ingredient information 122. In FIG. 5, the ingredient information 122 is information in which an item of a foodstuff used in cooking of food and a production area are associated with each other for each menu item. The provider 103 provides the terminal device 20 with, for example, a process image inclusive of information relating to foodstuffs used in a menu item included in the order information 121. The provider 103 specifies a menu item ordered by a user that is an information providing target on the basis of the order information 121, and searches the ingredient information 122 using the specified menu item as a search key, to thereby specify foodstuffs used in the menu item ordered by the user and production areas of the foodstuffs. The provider 103 provides the terminal device 20 with an image processed so that an image representing the specified foodstuffs and production areas is included in a process image (hereinafter referred to as a first image IM1).

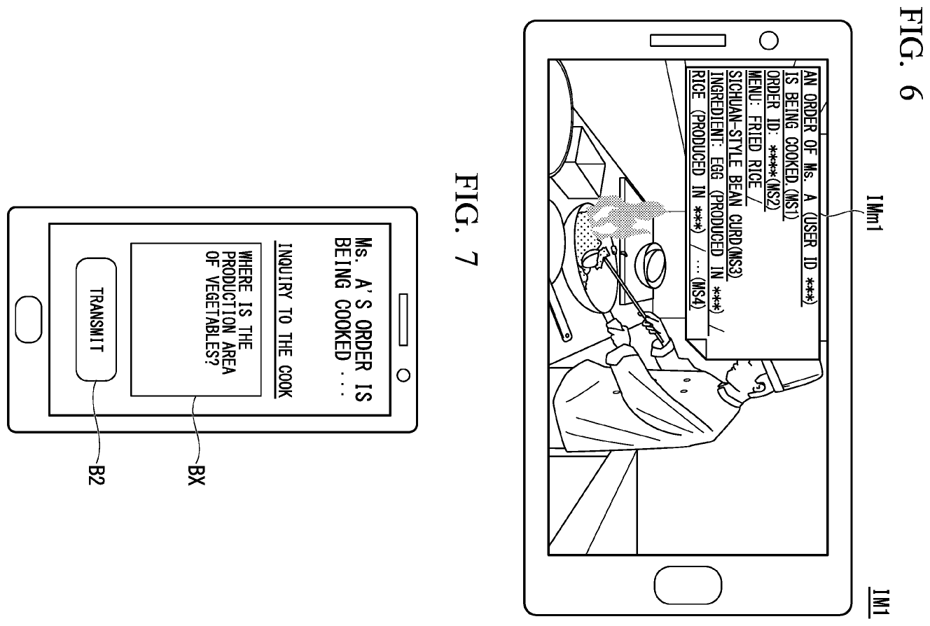

FIG. 6 is a diagram illustrating an example of the first image IM1 which is displayed by the terminal device 20. The first image IM1 of FIG. 6 includes a cooking image and a message image IMm1. The message image IMm1 includes, for example, a message MS1 indicating that food ordered by a user indicated by a user name (user ID) is being cooked, a message MS2 indicating an order ID, a message MS3 indicating an ordered menu item, and a message MS4 indicating foodstuffs and production areas used in a menu item. By confirming such an image, a user can confirm a menu item ordered by the user or foodstuffs used in cooking of the menu item while confirming that ordered food is being appropriately cooked.

The acceptor 104 accepts an inquiry from a user who has ordered food. An inquiry made by a user is, for example, a production area of a foodstuff, the presence or absence of an additive of a seasoning used by a cook, or the like.

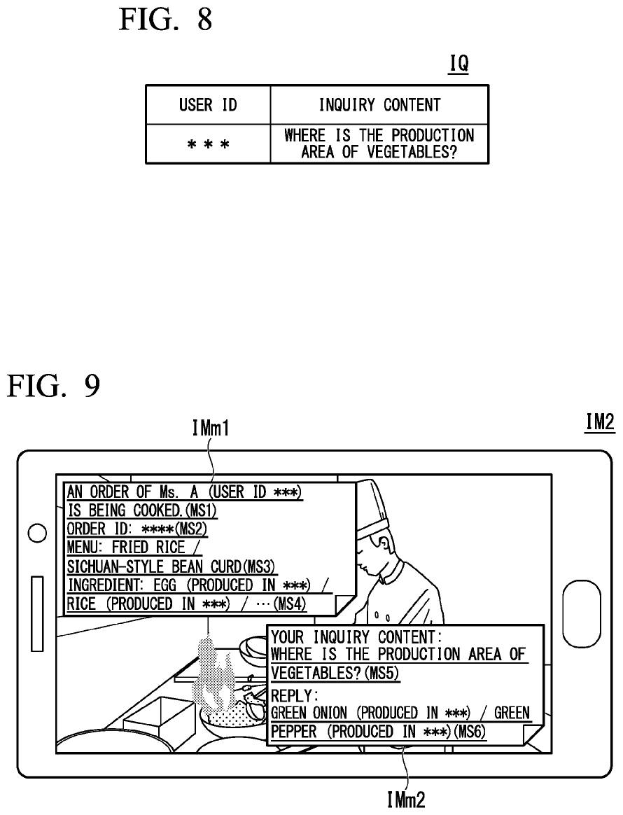

A user makes various inquiries for a cook or a store SF using, for example, an application which is executed in the terminal device 20. FIG. 7 is a diagram illustrating an example of an execution screen of an inquiry application which is executed in the terminal device 20. The inquiry application is an application for acquiring inquiry content for a cook or a store SF and providing the information providing device 10 with the acquired inquiry content. In a case where the inquiry application is started up, an interface image is displayed on the display screen of the terminal device 20. On the interface screen, a comment box BX for inputting inquiry content for a cook or a store SF, a button B1 for executing a process of providing (transmitting) the inquiry content which is input to the comment box BX to the information providing device 10, or the like is set. The acceptor 104 acquires inquiry information IQ of which a user inquires using the inquiry application of the terminal device 20. FIG. 8 is a diagram illustrating an example of content of the inquiry information IQ. The inquiry information IQ is information in which a user who has made an inquiry and inquiry content are associated with each other.

The acceptor 104 may acquire the inquiry information IQ using methods other than the inquiry application. For example, the acceptor 104 may acquire the inquiry information IQ by a person employed by a store SF directly inputting inquiry content transmitted by a user through communication with the person employed by a store to an input unit (not shown) connected to the information providing device 10. The acceptor 104 may acquire the inquiry information IQ on the basis of a text message transmitted to the information providing device 10 (or, a store SF) by a user.

The third acquirer 105 acquires a cook's reply. For example, the third acquirer 105 causes the display device 50 installed at a position that can be visually recognized by a cook to display the inquiry content indicated in the inquiry information IQ. A microphone (not shown) capable of detecting a cook's speech is installed in vicinity of the cook, and the microphone collects the cook's speech as a reply to the inquiry content displayed on the display device 50. The acceptor 104 converts the cook's speech content collected by the microphone into text through voice recognition, and acquires the result as the cook's reply. The provider 103 provides the terminal device 20 with an image processed so that an image representing the content of an inquiry indicated by the inquiry information IQ and the cook's reply acquired by the third acquirer 105 is included in a process image (hereinafter referred to as a second image IM2).

The third acquirer 105 may acquire the cook's reply using methods other than the acquisition of speech through a microphone. For example, the third acquirer 105 may acquire a reply by a person employed by a store transferring the content of the inquiry information IQ to a cooking image and directly inputting a reply obtained from a cook to an input unit (not shown) connected to the information providing device 10.

The cook's reply may be collected by microphones included in the imaging devices 40b and 40c, and be included in a process image. The cook may not reply through speech. For example, in a case where the content of an inquiry is “want to know the raw ingredient of a seasoning used in cooking” or the like, a cook may make a reply to an inquiry by bringing information indicating the raw ingredient of the seasoning (for example, a label attached to the container of a seasoning) close to the imaging devices 40b and 40c. In this case, the second acquirer 102 is an example of the “third acquirer.”

The third acquirer 105 may acquire a reply of a producer of foodstuffs used in cooking of food. For example, the producer has a terminal device TM capable of communication with the information providing device 10, the third acquirer 105 transmits the inquiry information IQ to the terminal device TM, and the terminal device TM causes a display to display inquiry content indicated in the received inquiry information IQ. The terminal device TM includes a microphone capable of detecting a producer's speech, and the microphone collects the producer's speech as a reply to an inquiry displayed on the display of the terminal device TM. The terminal device TM transmits collected voice information to the information providing device 10. The acceptor 104 converts the producer's speech content into text through voice recognition on the basis of the voice information received from the terminal device TM, and acquires the result as the producer's reply. The provider 103 provides the terminal device 20 with an image processed so that an image representing the content of an inquiry indicated by the inquiry information IQ and the producer's reply acquired by the third acquirer 105 is included in a process image. The third acquirer 105 may previously acquire the producer's replies such as a reply related to foodstuffs used in cooking of food, and provide a user with an appropriate reply among the replies which are previously acquired in a case where an inquiry about the producer from the user is made. The acceptor 104 and the third acquirer 105 may perform parallel processing so that a dialogue with a cook or a producer of foodstuffs is not mutually exchanged but can be performed in real time using a moving image as an image.

FIG. 9 is a diagram illustrating an example of a second image IM2 which is displayed by the terminal device 20. The second image IM2 shown in FIG. 9 includes a cooking image, the message image IMm1, and a message image IMm2 The message image IMm2 includes a message MS5 indicating a user's inquiry content and a message MS6 indicating a cook's reply. By confirming such an image, a user can confirm content of the user's inquiry and a reply to the inquiry while confirming that ordered food is being appropriately cooked. As a result, the information providing device 10 can eliminate a user's doubt about a commercial product.

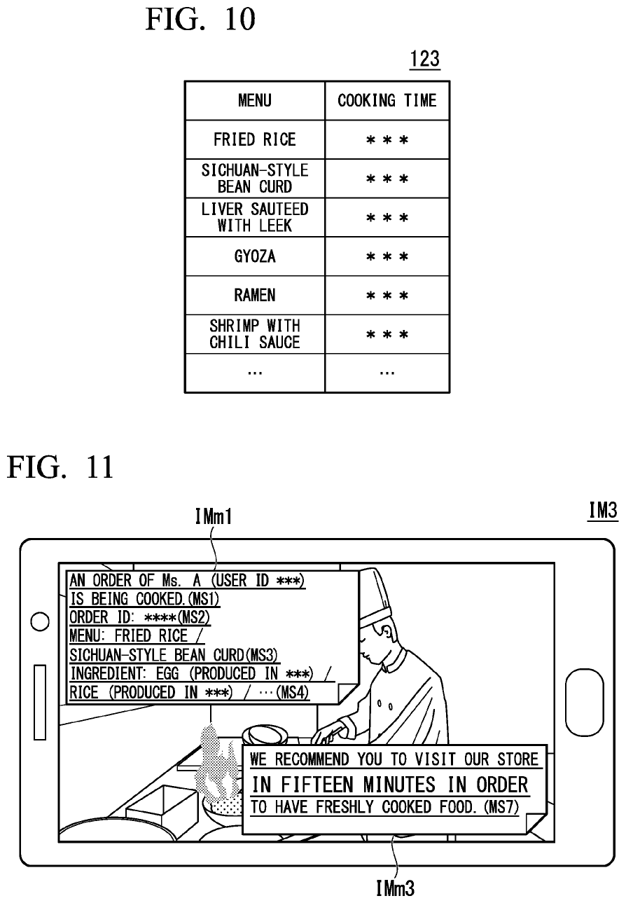

The first deriver 106 derives a recommended arrival time for each user on the basis of the order information 121 and the cooking time information 123. FIG. 10 is a diagram illustrating an example of content of the cooking time information 123. The cooking time information 123 is, for example, information in which a menu item and a cooking time for the menu item are associated with each other. The first deriver 106 specifies menu items included in a certain order record of the order information 121 and the number of menu items. The first deriver 106 searches the arrival time information 124 using the specified menu item as a search keys, and specifies a cooking time for the menu item. The first deriver 106 multiplies, for example, a cooking time for each specified menu item by the number of menu items, and derives a value obtained by adding up these as a total cooking time. Further, the first deriver 106 derives a time obtained by adding the derived total cooking time to an order time included in an order record as a recommended arrival time. The provider 103 provides the terminal device 20 with an image processed so that an image representing the total cooking time derived by the first deriver 106 is included in a process image (hereinafter referred to as a third image IM3). The first deriver 106 is an example of a “time deriver.” FIG. 11 is a diagram illustrating an example of the third image IM3 which is displayed by the terminal device 20. As shown in FIG. 11, the third image IM3 which is displayed by the display of the terminal device 20 includes a cooking image, the message image IMm1, and a message image IMm3. The message image IMm3 includes a message MS7 indicating a recommended arrival time (15 “minutes” in the drawing).

By confirming such an image, a user can move on to a store SF in accordance with a time at which cooking of food is completed while confirming the ordered food is being appropriately cooked. As a result, it is possible to provide a user with food at an appropriate time.

In the above, a case where the provider 103 generates various images and provides the images to the terminal device 20 has been described, but there is no limitation thereto. For example, a function of processing the message images IMm1 to IMm3 so that these images are included in a process image may be included in the terminal device 20. In this case, the provider 103 provides the terminal device 20 with pieces of information indicating the messages MS1 to MS7 and the process images. The terminal device 20 generates, for example, the first image IM1 to the third image IM3 on the basis of the pieces of information indicating the messages MS1 to MS7 provided from the information providing device 10 and the process images, and causes the display to display the generated images.

The terminal device 20 may provide the recommended arrival time to the vehicle system 3. The vehicle system 3 controls the vehicle V so as to arrive at a store SF at the recommended arrival time provided from the terminal device 20. In this case, the terminal device 20 and the vehicle system 3 communicate with each other through a Wi-Fi network, Bluetooth (registered trademark), a universal serial bus (USB (registered trademark)) cable, or the like, and transmit and receive information indicating the recommended arrival time. The information providing device 10 may provide the recommended arrival time directly to the vehicle system 3. In this case, information in which a user ID and an address of a communication device of the vehicle system 3 mounted in the vehicle V that a user identified by the user ID boards are associated with each other is stored in the storage 120 in advance, and the terminal device 20 transmits the recommended arrival time to the vehicle system 3 on the basis of the information.

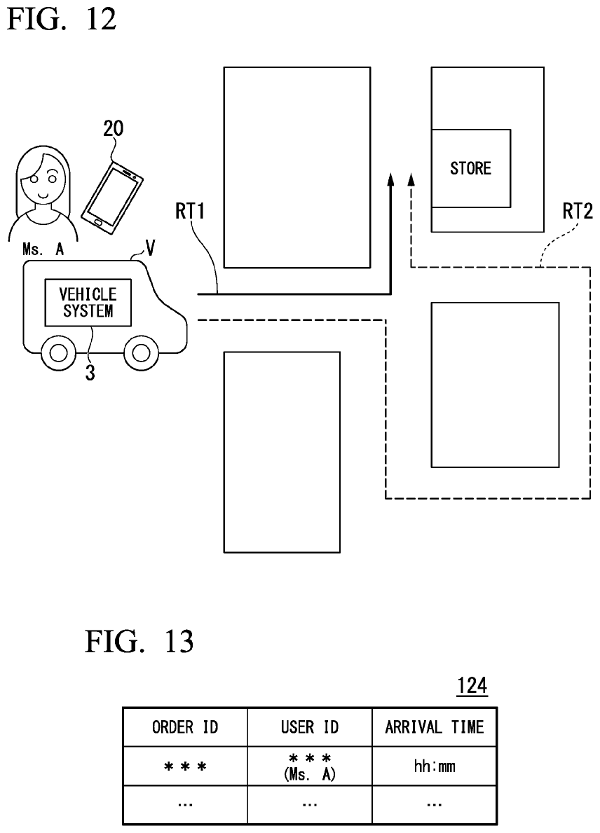

For example, the MPU included in the vehicle system 3 redetermines a recommended route so as to arrive at a store SF at a recommended arrival time on the basis of the recommended arrival time provided by the provider 103. A behavior planner included in the vehicle system 3 generates a target trajectory so as to travel in a recommended route redetermined by the MPU. FIG. 12 is a diagram illustrating an example of a recommended route redetermined by the MPU. The vehicle system 3 causes the vehicle V to travel to a store SF in accordance with a recommended route RT1 which is set at first with the store SF as a destination. In this case, when a recommended arrival time is acquired from the provider 103, the vehicle system 3 compares the recommended arrival time with a time at which the vehicle V is expected to arrive at the store SF (expected arrival time) in a case where the vehicle travels in the recommended route RT1, and causes the MPU to redetermine a recommended route in a case where the expected arrival time is early. A redetermined recommended route RT2 is a route which is set so that the expected arrival time is coincident with the recommended arrival time (that is, a roundabout route). Thereby, the vehicle system 3 can control the vehicle V so that a user arrives at the store SF at the recommended arrival time.

The second deriver 107 derives the cooking order of food which is cooked by a cook on the basis of the order information 121 and the arrival time information 124. FIG. 13 is a diagram illustrating an example of content of the arrival time information 124. The arrival time information 124 is, for example, information in which one or more arrival time records including an order ID, a user ID, and a time of arrival of a user identified by the user ID at the store SF are included. The arrival time is, for example, a time which is set by a user at the time of an order. The first acquirer 101 acquires, for example, an arrival time record indicating a user's arrival time together with an order record indicating the user's order content, and stores the arrival time record indicating the acquired arrival time as the arrival time information 124 in the storage 120. The second deriver 107 is an example of an “order deriver.” The arrival time may be included as one element of an order record indicating order content.

In this case, the first acquirer 101 may acquire the order record indicating order content, store an order ID, a user ID, an order time, menu items, and the number which are included in an order record as the order information 121 in the storage 120, and store the order ID, the user ID, and the arrival time as the arrival time information 124 in the storage 120. The first acquirer 101 may store the order record as the order information 121, and the order information 121 may include the arrival time information 124.

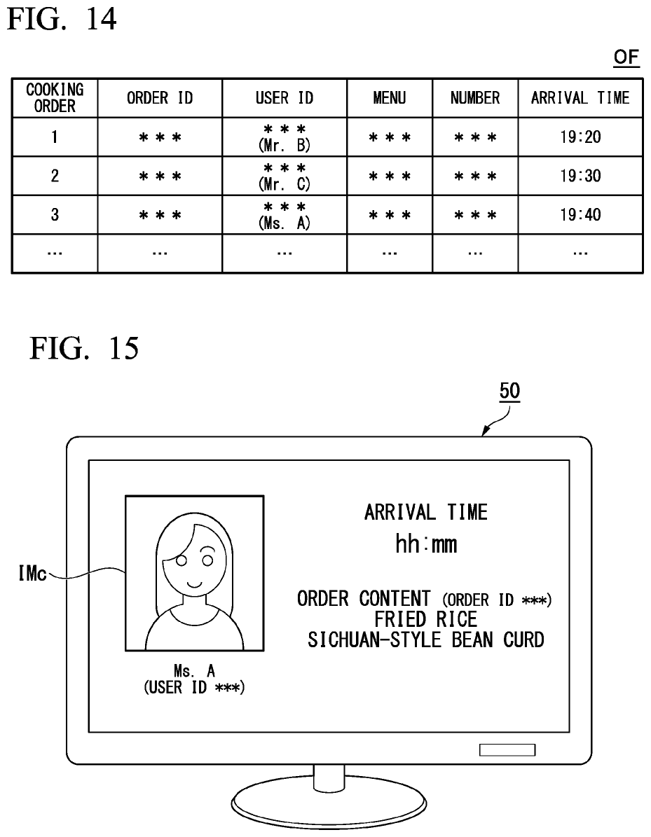

The second deriver 107 generates cooking order information OF on the basis of the arrival time information 124. FIG. 14 is a diagram illustrating an example of content of the cooking order information OF. As shown in FIG. 14, the cooking order information OF is information in which a cooking order, an order ID, a user ID, menu items, the number, and an arrival time are associated with each other. The second deriver 107 searches the order information 121 and the arrival time information 124, for example, using a certain order ID as a search key, and specifies a user ID, menu items, the number, and an arrival time with which the same order ID is associated. The second deriver 107 sorts each piece of information for each specified order ID in the order of early arrival time, and generates the cooking order information OF having a cooking order attached in the order of early arrival time.

The presentator 108 causes the display device 50 installed at a position that can be visually recognized by a cook to display information indicating the content of the cooking order information OF generated by the second deriver 107. Thereby, the presentator 108 causes a cook to confirm the cooking order information OF, and thus can prompt the cook to cook food in an appropriate order.

The fourth acquirer 109 acquires an image captured by a user (hereinafter referred to a customer image) from the user. For example, the user's face is shown in the customer image. For example, when an order service using the order processing device DD is used, the fourth acquirer 109 acquires the customer image registered by a user. The customer image may be included as one element of an order record. In this case, a user transmits the customer image to the order processing device DD or the information providing device 10 every order.

The presentator 108 causes the display device 50 installed at a position that can be visually recognized by a person employed by a store (particularly, a person employed by a store who is a receptionist) to display the customer image acquired by the fourth acquirer 109.

FIG. 15 is a diagram illustrating an example of a customer image which is displayed by the display device 50. On the display device 50, a user ID of a customer image, a user's name, an arrival time, an order ID, an ordered menu item, and the like may be displayed in addition to the customer image. Thereby, the presentator 108 causes a person employed by a store to confirm display of the display device 50, and thus can prompt an improvement in service when a user visits the store SF.

### Operation Flow: Process of Providing Process Image

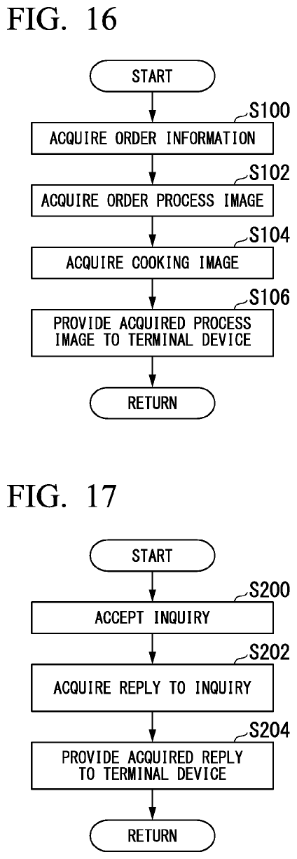

FIG. 16 is a flow chart illustrating an example of a flow of operations in a process of providing a process image to the terminal device 20. The first acquirer 101 acquires the order information 121 (step S100). The second acquirer 102 acquires an order process image from the imaging device 40a (step S102). The second acquirer 102 acquires a cooking image from the imaging devices 40b and 40c (step S104). The provider 103 provides the terminal device 20 with the process image acquired by the second acquirer 102 (step S106). The provider 103 may specify other information corresponding to an order (for example, the ingredient information 122) in step S106, and provide the terminal device 20 with the first image IM1 processed so that the specified information is included in the process image.

### Operation Flow: Process of Providing Reply to Inquiry

FIG. 17 is a flow chart illustrating an example of a flow of operations in a process of providing a reply to an inquiry to the terminal device 20. The acceptor 104 accepts the inquiry information IQ (step S200). The acceptor 104 accepts, for example, the inquiry information IQ by input of a person employed by a store to an input unit connected to the order processing device DD or the information providing device 10. The third acquirer 105 acquires a reply to inquiry content indicated in the inquiry information IQ accepted by the acceptor 104 (step S202). The third acquirer 105 acquires a reply by the collection of a cook's speech content using a microphone or input of a person employed by a store to an input unit connected to the information providing device 10. The provider 103 provides the terminal device 20 with the second image IM2 processed so that the message image IMm2 representing the reply acquired by the third acquirer 105 is included in the process image (step S204).

### Operation Flow: Process of Providing Recommended Arrival Time

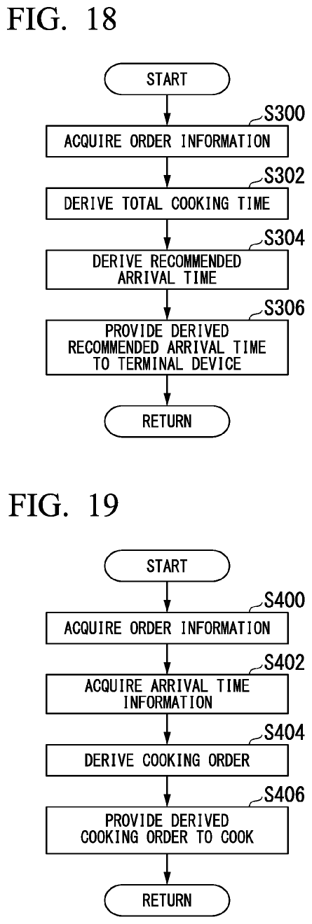

FIG. 18 is a flow chart illustrating an example of a flow of operations in a process of presenting a recommended arrival time to the terminal device 20. The first acquirer 101 acquires the order information 121 (step S300). The first deriver 106 derives a total cooking time on the basis of the order information 121 and the cooking time information 123 (step S302). The first deriver 106 derives a recommended arrival time by adding an arrival time to the derived total cooking time on the basis of the order information 121 (step S304). The provider 103 provides the terminal device 20 with an image representing the recommended arrival time and a process image (step S306). The provider 103 generates, for example, the third image IM3 processed so that the message image IMm3 representing the total cooking time is included in the process image, and provides the generated image to the terminal device 20.

### Operation Flow: Process of Presenting Cooking Order

FIG. 19 is a flow chart illustrating an example of a flow of operations in a process of presenting a cooking order to a cook. The first acquirer 101 acquires the order information 121 (step S400). The second deriver 107 acquires the arrival time information 124 (step S402). The second deriver 107 searches the order information 121 and the arrival time information 124 using a certain order ID as a search key, specifies a user ID, menu items, the number, and an arrival time with which the same order ID is associated, and sorts each piece of information for each specified order ID in the order of early arrival time, to thereby generate the cooking order information OF having a cooking order attached in the order of early arrival time (step S404). The presentator 108 presents a cook with the cooking order information OF generated by the second deriver 107 by displaying the information on the display device 50 that can be visually recognized by the cook (step S406).

### Conclusion of Embodiment

As described above, the information providing device 10 of the present embodiment includes the second acquirer 102 that acquires a cooking image obtained by capturing an image of a process of cooking food ordered by a customer (user) outside a store using the imaging device 40 and the provider 103 that provides the terminal device 20 used by the customer with the cooking image acquired by the second acquirer 102, and makes it possible for the user to confirm that ordered commercial product (food in this example) is being appropriately cooked.

In the above, a process of the information providing device 10 in a case where a user visits a store SF has been described, but there is no limitation thereto. For example, in a case where food is delivered to a delivery place desired by a user, the information providing device 10 may perform a process of presenting an image of a process of cooking or information relating to foodstuffs in addition to an expected delivery time of which the user's terminal device is notified at the time of an order.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information providing device comprising:
an image acquirer that acquires a cooking image obtained by capturing an image of a process of cooking food ordered by a customer outside a store using an imaging device; and
a provider that provides the cooking image acquired by the image acquirer to a terminal device which is used by the customer.

2. The information providing device according to claim 1, wherein the provider provides information relating to foodstuffs of the ordered food to the terminal device.

3. The information providing device according to claim 1, wherein the image acquirer further acquires an order process image obtained by capturing an image of a process until cooking is started after the food is ordered using an imaging device, and
the provider further provides the order process image to the terminal device.

4. The information providing device according to claim 1, wherein the cooking image includes an image representing identification information for identifying the customer who has ordered the food.

5. The information providing device according to claim 1, further comprising an acceptor that accepts a request for start of a dialogue with a cook of the food or a producer of foodstuffs used in the food from the customer who has ordered the food,
wherein the provider starts a dialogue through the terminal device in a case where the cook or the producer responding to the request for start of a dialogue accepted by the acceptor is able to respond thereto.

6. The information providing device according to claim 5, wherein the dialogue includes an inquiry from the customer for a cook of the food or the producer of foodstuffs used in the food, and
the cooking image includes an image representing a reply of the cook or the producer to the inquiry.

7. The information providing device according to claim 1, further comprising:
an order deriver that derives a cooking order on the basis of order information in which the food and identification information for identifying the customer who has ordered the food are associated with each other and information indicating a time of arrival of the customer at the store; and
a presentator that presents the cooking order derived by the order deriver to a cook.

8. The information providing device according to claim 1, further comprising a time deriver that derives a recommended time of arrival at the store for each customer on the basis of order information in which the food and identification information for identifying the customer who has ordered the food are associated with each other and information indicating a cooking time of the food,
wherein the provider provides the recommended arrival time derived by the time deriver to the terminal device or a vehicle control device of the corresponding customer.

9. A vehicle control system comprising:
the information providing device according to claim 8; and
a vehicle control device including a recognizer that recognizes an object including another vehicle which is present in the vicinity of a host vehicle and a driving controller that generates a target trajectory of the host vehicle on the basis of a state of the object recognized by the recognizer and controls one or both of speed and steering of the host vehicle on the basis of the generated target trajectory,
wherein the vehicle control device controls the host vehicle so as to arrive at the store at the recommended arrival time provided from the information providing device or through the terminal device.

10. An information providing method comprising causing a computer to:
acquire a cooking image obtained by capturing an image of a process of cooking food ordered by a customer outside a store using an imaging device; and
provide the acquired cooking image to a terminal device which is used by the customer.

11. A storage medium having a program stored therein, the program causing a computer to:
acquire a cooking image obtained by capturing an image of a process of cooking food ordered by a customer outside a store using an imaging device; and
provide the acquired cooking image to a terminal device which is used by the customer.
